(19) United States
(12) Patent Application Publication
(10) Pub. No.: US 2011/0040921 A1
(43) Pub. Date: Feb. 17, 2011

(54) KVM SWITCH HAVING UNIVERSAL INPUT AND PROGRAMMABLE USB HUB

(76) Inventors: Cheng-Sheng CHOU, Banciao City (TW); Hung-June Wu, Banciao City (TW)

Correspondence Address: HDLS Patent & Trademark Services, P.O. BOX 220746, CHANTILLY, VA, 20153-0746, US

(21) Appl. No.: 12/542,338

(22) Filed: Aug. 17, 2009

(51) Int. Cl. G06F 13/00

(52) U.S. Cl. 710/316

(57) ABSTRACT

A KVM switch of universal input and programmable USB hub includes a main control unit (MCU) chip, having a MCU circuit for controlling functions of the KVM switch, complete reports of console input devices, reading and corresponding transmissions of descriptors; a console device interface chip connected to the MCU; a console port, connected to the console device interface chip; a computer interface chip, connected to the MCU; a re-assignment USB hub chip, connected to the computer interface chip; and a computer port, connected to the re-assignment USB hub chip. Console USB I/O interfaces become dynamic and universal, such that USB devices connected to the control end correspond to the computer port to provide full compatibility, and the console ports can be connected to various USB devices without any limitation of device types, and the devices can be replaced freely during their operation to provide convenient operations and applications.

### BACKGROUND OF THE INVENTION

1. Field of the Invention

The present invention relates to a keyboard-video-mouse (KVM) switch of a universal input and programmable universal serial bus (USB) hub, and more particular to a KVM switch adopting a dynamic and universal installation of a console USB input/output interface to provide full compatibility and tremendous convenience for operations and applications.

2. Description of Prior Art

At present, a KVM switch is generally used for achieving the effect of controlling and operating a plurality of computers (or servers) by one set of peripherals as shown in FIG. 1, and an end of the KVM switch 90 is connected to a plurality of computers 91, and another end is connected to a keyboard 92, a video display device 93, and a mouse 94. Although the conventional KVM switch can share the function of the keyboard-video-mouse set by its connection. However, a console of the conventional KVM switch includes a USB input/output device connected to a fixed input/output interface and allows users to connect the keyboard, video display device and mouse to specific ports only, but the use of ports cannot be changed or other USB devices such as flash devices, card readers, and digital cameras cannot be connected freely, and thus the scope of applicability and the convenience of operations are limited. Therefore, many USB devices achieve the function of switching operations by switching the connection of a hub, and such arrangement is not an ideal application, since the console input/output interface is fixed, and a corresponding simulation program and a compatible format are limited. The compatibility issue occurs in various different USB devices. Furthermore, a complicated switching circuit and a control firmware programs are required for switching the connection of the hub, not mentioning the separate switching control of any port to a computer port. Therefore, the structure and application of the USB input/output interface of present existing KVM switches and hubs require further improvements.

In view of the shortcomings of the conventional KVM switch, the inventor of the present invention based on years of experience in the related industry to conduct extensive researches and experiments, and finally developed a KVM switch having a universal input and programmable USB hub in accordance with the present invention, and the KVM switch can be adjusted dynamically to provide convenience and economic benefits.

### SUMMARY OF THE INVENTION

It is a primary objective of the present invention to provide a KVM switch having a universal input and programmable USB hub and using an appropriate control determination mechanism to change a console USB input/output interface into a dynamic and universal form, such that USB devices connected to the console corresponding to computer ports provide a full compatibility, and various USB devices can be connected to the console port without any limitation to the device type, and the USB devices can be replaced during operation to provide tremendous convenience to operations and applications.

Another objective of the present invention is to provide a KVM switch having a universal input and programmable USB hub, such that the USB hub can use a programmable USB hub chip for a programmable setup and a connection by the console chip of the KVM switch without going through a complicated switch circuit to reassign the connection of each port of the USB hub chip. The invention not just achieves a connection of any port to any computer port independently, but also simplifies the original complicated hardware circuit, lowers the cost and enhances the life expectancy and reliability of the KVM switch.

A further objective of the present invention is to provide a KVM switch having a universal input and programmable USB hub, wherein each port of the USB hub can be connected to different computer ports, so that each port of the USB hub can be bridged with different computers to constitute a KVM switch with the function of bridging a computer port.

To achieve the aforementioned objectives and effects, the present invention provides a KVM switch having a universal input and programmable USB hub, which comprises a main control unit (MCU) having a MCU circuit for controlling functions of the KVM switch, complete reports of console input devices, readings and corresponding transmissions of descriptors; a console device interface chip connected to the MCU; a console port, connected to the console device interface chip; a computer interface chip, connected to the MCU; a re-assignment USB hub chip, connected to the computer interface chip; and a computer port, connected to the re-assignment USB hub chip, such that the computer interface circuit transmits the complete reports and descriptors of the console input device to a different computer port according to the control of the MCU, such that a connected computer has a similar effect of connecting a console input/output device directly.

In another aspect, the KVM switch having a universal input and programmable USB hub comprises a main control unit (MCU) chip, a USB hub port; a re-assignment USB hub chip connected to the USB hub port having a main control unit (MCU) circuit, for controlling all functions of the KVM switch, and complete reports of a console input device, readings of a descriptor and corresponding transmissions; a console device interface chip, connected to the MCU; a console port, connected to the console device interface chip; a computer interface chip, connected to the MCU; a re-assignment USB hub chip, connected to the computer interface chip and the USB hub port, and the USB hub port being connected to the re-assignment USB hub chip; and a computer port, connected to the re-assignment USB hub chip.

To make it easier for the examiner to understand the technical characteristics, features and effects of the present invention, we use preferred embodiments together with related drawings for the detailed description of the present invention as follows.

### BRIEF DESCRIPTION OF DRAWINGS

FIG. 1 is a schematic view of a structure of a conventional KVM switch;

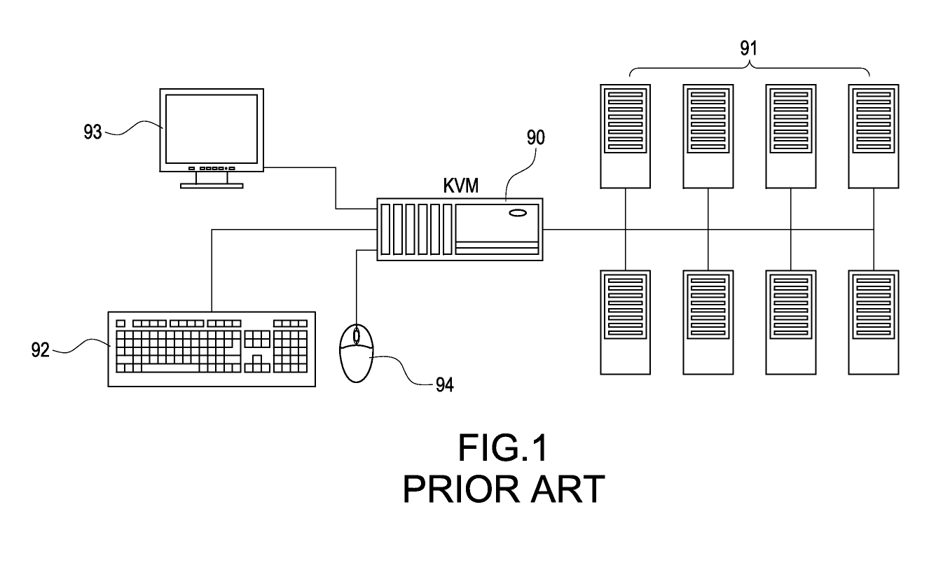

FIG. 2 is a schematic block diagram of a basic structure of the present invention; and

FIG. 3 is a schematic block diagram of a re-assignment USB hub chip of current market sales, which can be used for the USB hub chip 20 in FIG. 2.

### DETAILED DESCRIPTION OF THE INVENTION

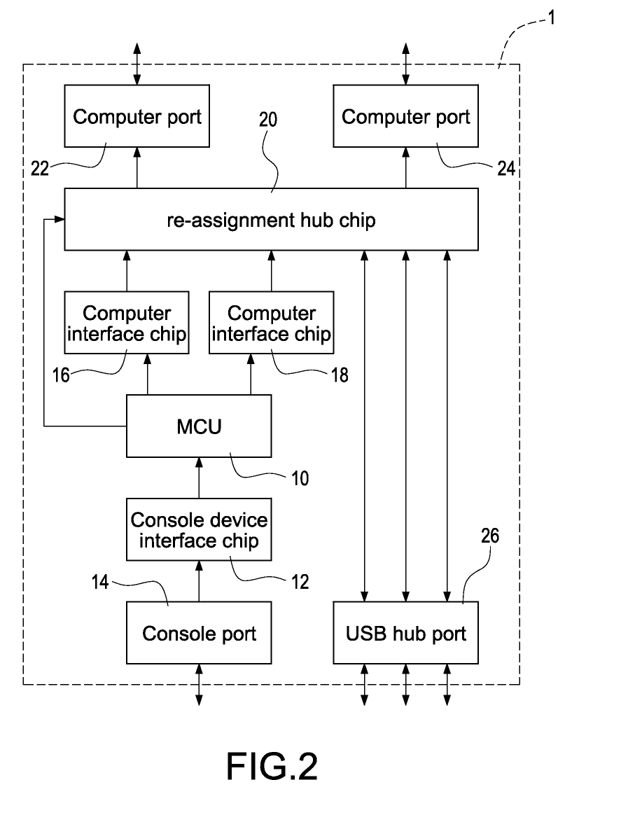

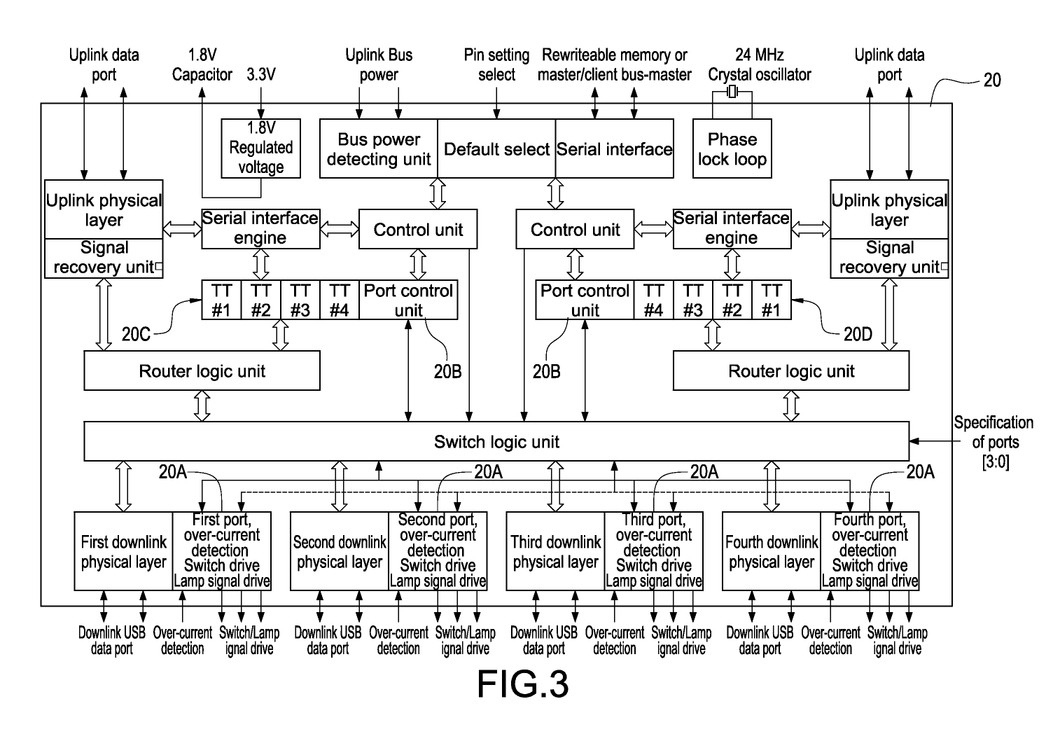

With reference to FIG. 2 for a KVM switch having a universal input and programmable USB hub of the present invention, the KVM switch 1 comprises a main control unit (MCU) 10 having a MCU circuit for controlling all functions of the KVM switch 1 and complete reports of a console input device, readings of descriptors and corresponding transmissions, and the MCU 10 is connected to a console device interface chip 12, and the console device interface chip 12 is connected to a console port 14, and the console port 14 includes a plurality of ports used for connecting USB peripheral devices, and the MCU 10 is connected to computer interface chips 16, 18 separately, and the computer interface chips 16, 18 are connected to a re-assignment USB hub chip 20, and the re-assignment USB hub chip 20 includes a computer interface circuit for transmitting complete reports of a console input device and readings of descriptors to different computer port interfaces (such as the computer ports 22, 24 as shown in the figure), such that the connected computer can achieve a similar effect of directly connecting the console input/output device. As shown in FIG. 3, the re-assignment USB hub chip 20 includes four downlink ports 20A (USB device/Port #1˜Port #4) and two uplink ports 20B (Computer end/Port controller), and the re-assignment USB hub chip 20 can be controlled by an external microcomputer chip to assign any port (including but not limited to 1˜4) to be connected to the two uplink ports freely (or alternately, but not limited to such arrangement only), such as the connections of the downlink port #1, port #2, port #3 and port #4 to PC1; or the downlink port #1, port #2 and port #3 to PC1 and the downlink port #4 to PC2; or the downlink port #1 and port #2 to PC1 and the downlink port #3 and port #4 to PC2; or the downlink port #1 to PC1 and the downlink port #2, port #3 and port #4 to PC2; or the downlink port #1, port #2, port #3 and port #4 to PC2; or the downlink port #1 and port #3 to PC1 and the downlink port #2 and #4 to PC2; or the downlink port #1 and port #4 to PC1 and the downlink port #2 and port #3 to PC2; or the downlink port #1, #3 and #4 to PC 1 and the downlink port #2 to PC2; and the number of combinations is equal to 2⁴=16. Since the four downlink ports (USB device) have transaction translations (T/T) 20C, 20D independently corresponding to two or more uplink ports (Computer end), so that each downlink port has a quick transmission rate with any of the uplink ports without being affected by a full load of downlink ports. Therefore, the signal of a device of the console port 14 is transmitted directly through the MCU 10 and related circuits to a selected computer interface chip 16, 18, and the re-assignment hub chip 20 operates according to an instruction issued by the MCU 10. The computer ports 22, 24 are connected to a computer (not shown in the figure), wherein the re-assignment hub chip 20 is connected to the MCU 10, and the USB hub port 26 includes a plurality of ports connected to the re-assignment hub chip 20 for transmitting the signal of the device at the USB hub port 26 through the USB hub chip (which is the re-assignment hub chip 20) to a selected computer (which the computer ports 22, 24) directly. In other words, the MCU 10 switches the interface of every USB hub port 26 of the re-assignment hub chip 20 to a specified computer interface (including the computer interface chips 16, 18 and computer ports 22, 24) through the circuit of the re-assignment hub chip 20 according to a switching instruction. In general, the USB hub port 26 is installed at an end of the same area of the console port 14.

The MCU 10 of the KVM switch 1 reads information including a complete report and device descriptors of USB devices of a periphery device connected to the console port 14 through the console device interface chip 12, and then the MCU 10 transmits such information to the computer interface chips 16, 18 to complete a dynamic correspondence of the devices, so that a computer connected to the computer ports 22, 24 can be communicated and connected completely to overcome the compatibility issue and allow users to connect other devices or reset the correspondence and connection anytime. The invention has the advantages and effects as follows:

1. If a keyboard is connected and the computer is powered on, the BIOS will receive complete USB communications and have no compatibility issue with the type of a keyboard or computer operating system, so as to achieve the effect of connecting different platforms.

2. If the console port 14 is connected to a device other than the keyboard, the MCU 10 can set a programmable switching hot key such as “PgUp” or “PgDn” of a mouse according to the properties of the connected device and the settings of corresponding switch controls, or even can switch a touch panel, so that the switching mechanism can be expanded from the keyboard to other input devices.

3. The computer interface chips 16, 18 are in a dynamic correspondence mode, so that if the console is connected by a device other than the keyboard (such as a mouse, a joystick or a touch panel), the computer interface chips 16, 18 can be reconfigured by the MCU 10 anytime without requiring a rebooting or burning process.

4. The device connected to the console port can be a personal system/2 (PS/2) USB adapter, and the computer interface chips 16, 18 respond to complete USB communications to achieve the function of connecting a plurality of console interface devices.

Various devices connected to the USB hub port 26 can issue a switching instruction to the MCU 10 through a hot key or an on screen display (OSD) screen, and the MCU 10 sets and controls the re-assignment hub chip 20 according to an instruction to connect every port of the USB hub port 26 to the set computer ports 22, 24 through the USB hub circuit (of the re-assignment hub chip 20), so that the USB hub ports 26 can be switched synchronously by the console device or any of the USB hub ports 26 can be connected to any computer port 22, 24 alternately, and all settings for completing a switching and a wire wrapping can be completed by the re-assignment hub chip 20 without requiring any external switch circuit or control circuit, so as to achieve a reduced structure, a lower cost, a more powerful function, a higher reliability and a longer life than the conventional KVM switch.

Since the present invention includes a re-assignment hub interface (or a re-assignment hub chip 20), therefore the USB hub port 26 can be used for bridging a computer connected to the two computer ports 22, 24, and the KVM switch of the present invention also has the function of bridging a computer.

The KVM switch having a universal input and programmable USB hub of the invention uses the MCU to complete transmitting complete information to the computer interface chip to complete the dynamic correspondence function, such that a computer connected to the computer port can be communicated and connected to overcome the compatibility issue without going through a complicated switching circuit to reassign every port of the reassignment USB hub chip, so as to connect various USB devices by the console port without any limitation of the device type, and the USB devices can be installed or replaced freely during the operation. Unlike the existing KVM switch, the present invention provides tremendous convenience and economic benefits. In addition, the MCU can set and control the reassignment USB hub chip by an instruction to connect every port of the USB hub port with a computer port set up by the reassignment USB hub chip, such that the USB hub ports can be switched synchronously according to the console device. The invention not only assigns a connection of any port with any computer independently, but also reduces the original complicated hardware circuit to lower the cost and improve the life and reliability of the KVM switch.

The present invention is illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A keyboard-video-mouse (KVM) switch having a universal input and programmable universal serial bus (USB) hub, comprising:
a main control unit (MCU), having a MCU circuit, for controlling all functions of the KVM switch, and complete reports of a console input device, readings of a descriptor and corresponding transmissions;
a console device interface chip, connected to the MCU;
a console port, connected to the console device interface chip;
a computer interface chip, connected to the MCU;
a re-assignment USB hub chip, connected to the computer interface chip; and
a computer port, connected to the re-assignment USB hub chip;
thereby, the computer interface chip transmits the complete reports and descriptors of the console input device to a different computer port according to a control of the MCU, such that a connected computer has a similar effect of connecting a console input/output device directly.

2. The KVM switch having a universal input and programmable USB hub of claim 1, further comprising a USB hub port connected to the re-assignment USB hub chip.

3. The KVM switch having a universal input and programmable USB hub of claim 1, wherein the re-assignment USB hub chip includes four downlink ports and two uplink ports, and the four downlink ports are provided for independently processing a conversion unit and corresponsive to the two uplink ports.

4. The KVM switch having a universal input and programmable USB hub of claim 1, wherein the USB hub port includes a plurality of ports.

5. The KVM switch having a universal input and programmable USB hub of claim 2, wherein the re-assignment USB hub chip is connected to the MCU.

6. A keyboard-video-mouse (KVM) switch having a universal input and programmable universal serial bus (USB) hub, comprising: a main control unit (MCU) chip, a USB hub port; a re-assignment USB hub chip connected to the USB hub port having a main control unit (MCU) circuit, for controlling all functions of the KVM switch, and complete reports of a console input device, readings of a descriptor and corresponding transmissions;
a console device interface chip, connected to the MCU;
a console port, connected to the console device interface chip;
a computer interface chip, connected to the MCU;
a re-assignment USB hub chip, connected to the computer interface chip and the USB hub port, and the USB hub port being connected to the re-assignment USB hub chip; and
a computer port, connected to the re-assignment USB hub chip.

7. The KVM switch having a universal input and programmable USB hub of claim 6, wherein the USB hub port includes a plurality of ports.
